(19) United States
(12) Patent Application Publication
(10) Pub. No.: US 2022/0113986 A1
(43) Pub. Date: Apr. 14, 2022

(54) SECURE CONFIGURATION OF PARAMETERS AND APPLICATIONS ON INITIAL BOOT OF A DEVICE INCLUDING A CAMERA

(71) Applicant: Plantronics, Inc., Santa Cruz, CA (US)

(72) Inventor: Cody Clay SCHNACKER, Thornton, CO (US)

(21) Appl. No.: 17/070,135

(22) Filed: Oct. 14, 2020

(51) Int. Cl. G06F 9/4401; G06K 7/14; G06K 19/06

(52) U.S. Cl. CPC G06F 9/4416; H04N 7/15; G06K 19/06037; G06K 7/1417

(57) ABSTRACT

QR codes are used to provide configuration information to devices that cannot access a provisioning server at initial boot. A device serial number is included in the QR code data to limit the possibility of the QR code being used to activate apps or install parameter data on unauthorized devices. Multiple devices are configured by providing multiple serial numbers in the QR code data, thus maintaining security but decreasing the number of QR codes that need to be generated and matched with devices. The QR code data can be encrypted to provide additional security. When the device initially boots, if the device cannot access a provisioning server to be configured, a request for a QR code is made. The device camera waits for a QR code to be presented and completes the initial configuration operation when the QR code data contains the serial number of the device.

### TECHNICAL FIELD

This disclosure relates generally to electronic devices including a camera and relates particularly to initial configuration of applications and parameters of the devices.

### BACKGROUND

Most modern electronic devices need some level of configuration or personalization. As provided from the factory, each device is unconfigured and must be configured upon boot of the device. The needed configuration information varies according to the particular device. Videoconferencing endpoints and voice over Internet Protocol (VoIP) phones need at least IP information to allow them to connect to other devices. Given the popularity of communication platforms, such as Zoom®, Teams® and GoTo®, the videoconferencing endpoints and VoIP phones can utilize embedded applications to natively operate with a given communication platform. Company issued cell phones and laptops need selected software applications desired by the company to be installed and individual users set up.

Various methods have been developed to simplify this initial configuration. For example, upon initial boot, videoconferencing devices and VoIP phones attempt to connect to a provisioning server to obtain the needed configuration information, such as parameters like IP addresses or applications to be loaded. If everything operates correctly, the needed parameters and applications are loaded onto the device from the provisioning server, the device reboots and is ready for operation. But many times, things do not operate correctly. The provisioning server may not be accessible for a number of reasons, such as lack of Internet or network access, firewalls blocking access or the need for passwords and the like. Under those conditions, the device just waits in a locked state, needing individual attention by a human operator to proceed with configuration. The human operator has to enter a series of commands, often many characters long, even random character strings, to get the configuration process started. The human operator configuration process is tedious at best and often frustrating and becomes more so if many devices must be configured in a major installation. This situation of everything not operating correctly occurs often enough that alternatives to the human operator configuration process are desirable.

### SUMMARY

In examples of this description, QR codes are used to provide configuration information to devices that cannot access a provisioning server at initial boot. A device serial number is included in the QR code data to limit the possibility of the QR code being used to activate apps or install parameter data on unauthorized devices. Multiple devices are configured by providing multiple serial numbers in the QR code data, thus maintaining security but decreasing the number of QR codes that need to be generated and matched with devices. The QR code data can be encrypted to provide additional security. When the device initially boots, if the device cannot access a provisioning server to be configured, a request for a QR code is made. The device camera waits for a QR code to be presented and completes the initial configuration operation when the QR code data contains the serial number of the device.

### BRIEF DESCRIPTION OF THE DRAWINGS

For illustration, there are shown in the drawings certain examples described in the present disclosure. In the drawings, like numerals indicate like elements throughout. The full scope of the inventions disclosed herein are not limited to the precise arrangements, dimensions, and instruments shown. In the drawings:

FIG. 1 is an illustration of a videoconferencing device, in accordance with an example of this disclosure.

FIG. 2 is an illustration of a network containing videoconferencing devices of FIG. 1.

FIG. 3 is a flowchart of initial boot configuration of a videoconferencing device of FIG. 1.

FIG. 4 is an illustration of data format used to perform initial boot configuration of a videoconferencing device of FIG. 1.

FIG. 5 is an illustration of a cell phone displaying a QR code used to perform initial boot configuration of a videoconferencing device of FIG. 1.

FIG. 6 is an illustration of a cell phone displaying a QR code used to perform initial boot configuration of a plurality of videoconferencing devices of FIG. 1.

FIG. 7 is an illustration of a printed page containing a plurality of QR codes used to perform initial boot configuration of a plurality of videoconferencing devices of FIG. 1.

### DETAILED DESCRIPTION

In the drawings and the description of the drawings herein, certain terminology is used for convenience only and is not to be taken as limiting the examples of the present disclosure. In the drawings and the description below, like numerals indicate like elements throughout.

Throughout this disclosure, terms are used in a manner consistent with their use by those of skill in the art, for example:

The phrase QR code is used to represent any machine-readable code, such as one-dimensional and two-dimensional bar codes and their combination, that contains sufficient data capacity to convey the needed information for configuration of the device being configured.

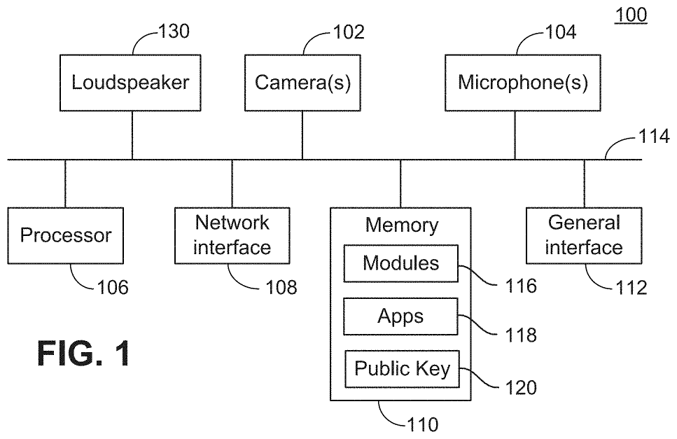

FIG. 1 illustrates aspects of a device 100, in accordance with an example of this disclosure. Typical devices 100 include videoconference endpoints and VoIP phones that contain a camera and a display. The device 100 can include cell phones, tablets and other portable devices. The device 100 can include laptop computers, desktop computers with cameras, and the like. The device 100 can include any other device that needs configured or personalized and includes or can include a camera and a display.

The device 100 includes a loudspeaker 130, camera(s) 102 and microphone(s) 104 interfaced via interfaces to a bus 114. The device 100 also includes a processing unit 106, a network interface 108, a memory 110 and an input/output general interface 112, all coupled by bus 114. Bus 114 is illustrative and any interconnect between the elements can used, such as Peripheral Component Interconnect Express (PCIe) links and switches, Universal Serial Bus (USB) links and hubs, and combinations thereof. The cameras 102 and microphones 104 can be contained in a housing containing the other components or can be external and removable, connected by wired or wireless connections.

The processing unit 106 can include digital signal processors (DSPs), central processing units (CPUs), graphics processing units (GPUs), dedicated hardware elements, such as neural network accelerators and hardware codecs, and the like in any desired combination.

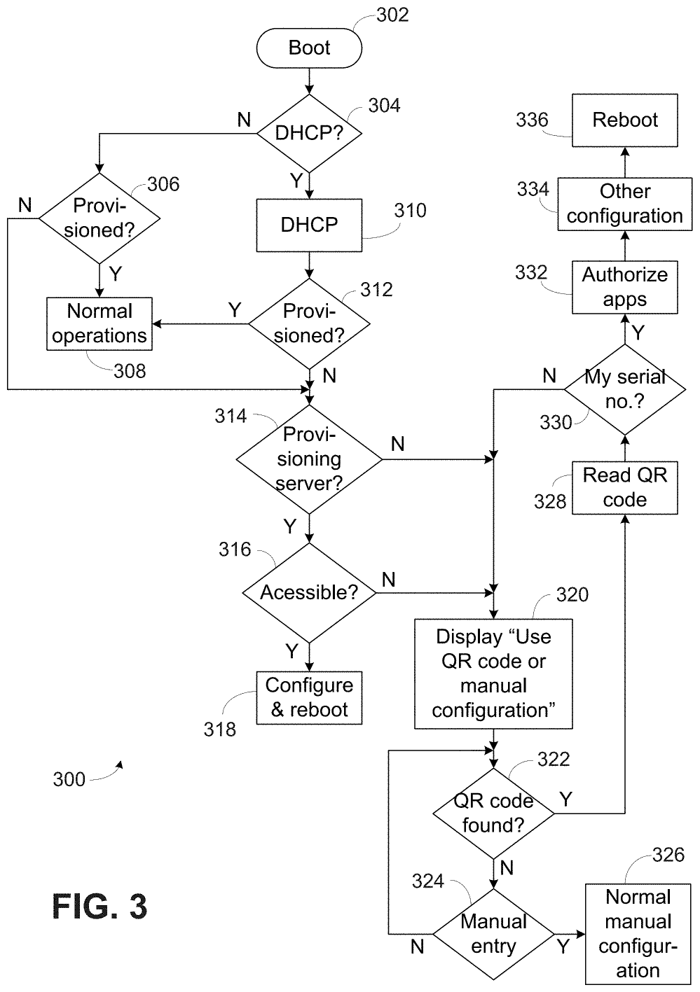

The memory no can be any conventional memory or combination of types of conventional memory, such as SDRAM and flash memory, and can store modules 116 in the form of software and firmware, generically programs, for controlling the device 100. The memory no can also store applications 118 which execute on the device 100 and public keys 120, used for secure communication. The modules 116 can include operating systems, a graphical user interface (GUI) that enables users to control the device 100, and algorithms for processing audio/video signals and controlling the cameras 102. The modules 116 include a boot process for the device 100, the process including initial boot configuration operations as shown in FIG. 3 and described below. SDRAM can be used storing video images of video streams and audio samples of audio streams and can be used for scratchpad operation of the processing unit 106.

The network interface 108 enables communications between the device 100 and other devices and can be wired, wireless or a combination. In one or more examples, the general interface 112 provides data transmission with local devices such as a keyboard, mouse, printer, projector, display, external loudspeakers, additional cameras, and microphone pods, etc.

The cameras 102 and the microphones 104 capture video and audio, respectively, in the videoconference environment and produce video and audio streams or signals transmitted through the bus 114 to the processing unit 106. In at least one example of this disclosure, the processing unit 106 processes the video and audio using algorithms in the modules 116. Processed audio and video streams can be sent to and received from remote devices coupled to network interface 108 and devices coupled to general interface 112. This is just one example of the configuration of a device 100 and other configurations are well known.

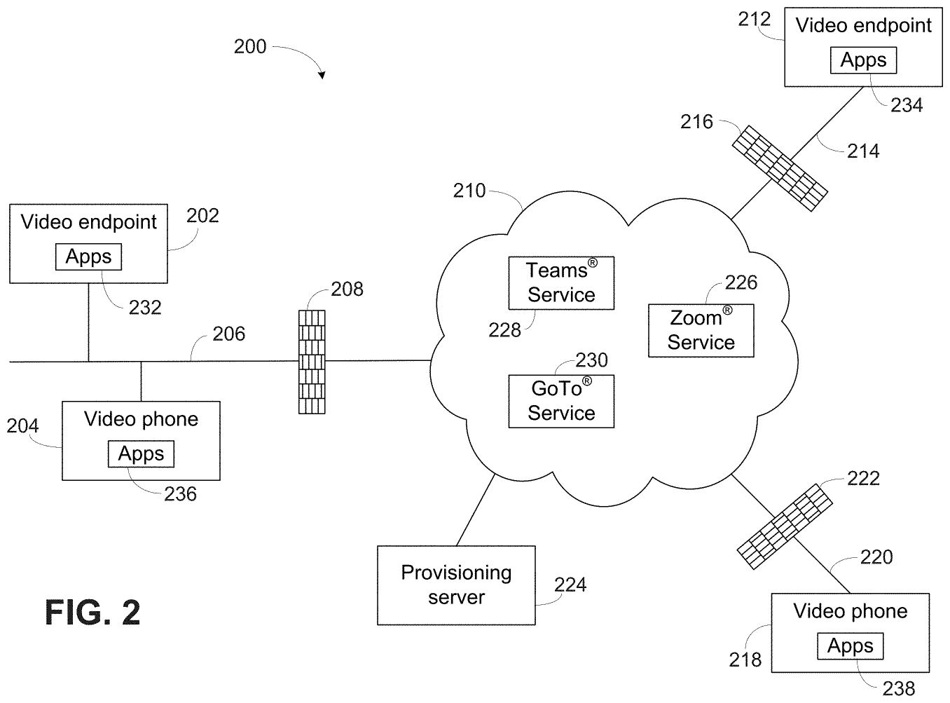

Referring now to FIG. 2, a communication network 200 is illustrated. A video endpoint 202 and a video phone 204 are connected via a network 206 to a firewall 208. Firewall 208 is connected to the Internet 210. A second video endpoint 212 is connected by a network 214 to a firewall 216, with the firewall 216 connected to the Internet 210. A second video phone 218 is connected using a network 220 to a firewall 222, with the firewall 222 connected to the Internet 210. A provisioning server 224 is connected to the Internet 210. Accessible via the Internet 210 are three communications platforms or services, a Zoom® service 226, a Teams® of service 228 and a GoTo® service 230. The three services 226, 228, 230 are communication platforms that allow collaboration and conferencing between video endpoints and video phones and the like. Each of the video endpoints 202 and 212 include applications 232, 234 respectively. Similarly, the video phones 204 and 218 include applications 236, 238. These

applications 232, 234, 236, 238 include programs or apps customized to interact with one of the services 226, 228, 230 in various examples. In other examples, a video phone may contain a browser and the apps can be browser applications. By installing, for example, a Zoom app from the applications 232 into the video endpoint 202, the video endpoint 202 natively interacts with the Zoom service 226, not requiring additional modification steps or connection steps. Similarly, a video phone 204 can install a GoTo app from the applications 236 and then be native to the GoTo service 230. By having particular apps for particular services, the video endpoint interaction with the particular service is greatly simplified for user operation. In one example, the apps for each of the three services 228, 226, 23o are located in each of the applications 232, 234, 236, 238 but need particular activation keys to be activated to allow native operation with the particular service. Installing the activation keys is preferably done during the initial configuration process to simplify operation by users. In a different example, the desired apps are indicated in the QR code data and the apps are retrieved from an alternate provisioning server, whose IP address is provided in the QR code data, and then installed into the applications 232, 234, 236, 238 of the particular video endpoint 202, 212 or video phone 204, 218. In this case activation keys are not required for the specific apps, as access to the provisioning server 224 controls the distribution, but an access key may be used.

Referring now to FIG. 3, a flowchart of initial configuration for one or more examples of the present disclosure is illustrated. In step 302, the device 100, such as a video endpoint or video phone, boots. In step 304, the device 100 determines if it is configured for Dynamic Host Configuration Protocol (DHCP) operation. If it is not configured for DHCP operation, then it has a static IP address. In step 306, it is determined if the device 100 has already been provisioned. If so, this is a completely configured device and in step 308 normal operations commence. This path from step 302 to step 304 to step 306 to step 308 is the normal path for a fully configured device after the static IP address has been installed. If the device has been determined in step 304 to be set for DHCP operation, in step 310 DHCP is performed and an IP address is obtained. In step 312, it is determined if the particular device 100 has been provisioned. If so, operations proceed to step 308 for normal operation of the device 100. If the device 100 has not been provisioned as determined in step 306 or in step 312, in step 314 it is determined if a provisioning server has been identified. For example, in DHCP this is one parameter available in the response to a DHCP request. In the case of a static IP configuration, the address of a DHCP server can be installed at the time of installation of the static IP address. If in step 314 it is determined that a provisioning server has been identified, in step 316 it is determined if that provisioning server is accessible. As described above, in many cases the provisioning server may not be accessible. For example, referring to FIG. 2, the provisioning server 224 is located outside of the firewall 208 such that if the video endpoint 202 or video phone 204 cannot access the provisioning server 224 through the firewall 208, the provisioning server may have been identified but it will be inaccessible. If the provisioning server as determined in step 316 to be accessible, in step 318 the device 100 is configured and rebooted.

If no provisioning server has been identified in step 314 or if the provisioning server as inaccessible as determined in step 316, operation proceeds to step 320 where the device 100 provides a display on the user interface of the device that indicates to use a QR code or manual configuration. The device 100 begins monitoring the camera for the presentation of a QR code to the device 100. In step 322, it is determined if a QR code has been placed in front of the camera. If not, a check is made in step 324 to determine if manual entry has been indicated. If manual entry has been indicated, in step 326 normal manual configuration is performed, which ultimately results in the device rebooting. If no manual entry has been indicated in step 324, operation returns to step 322 to continue to loop looking for a QR code or manual entry indication.

If a QR code was found to be present in front of the camera in step 322, in step 328 the QR code is read and decoded. In one example, the data in the QR code is encrypted using a private key. The public key 120 is stored in the device 100 to decrypt the encoded QR code data. This encryption provides security to minimize unauthorized installation of apps or other configuration items. In step 330, it is determined if the serial number of the device 100 matches serial numbers present in the QR code data. Use of the serial number secures the use of the QR code to specific devices, so that a QR code cannot be used on other devices to enable features or apps or provide configuration that is not appropriate to the other device. When used in combination with the QR code data encryption, unauthorized installation or configuration is minimized. If it is determined in step 330 that the serial number is not present in the QR code data, operation returns to step 322 to display the use a QR code or manual configuration screen. If the serial number was present as determined in step 330, in step 322 the particular apps are authorized using activation key values contained in the QR code in one example. In step 334, any other configuration information besides the activation keys provided in the QR code data is installed. In one example this includes the IP address and other addressing information for the particular device.

By displaying one QR code, the device can be configured for all the apps needed for operation and can even obtain a static IP address and other parameters needed for operation, without the need for manual entry of long strings of numbers and letters, simplifying initial configuration of the device 100. After step 324, the device reboots to reinitialize and utilize the configuration and apps that have been authorized or installed.

While the above example automatically enters QR code mode after failing to access a provisioning server, QR code mode, such as step 320, can be accessed in one example by a user selectable option. A configuration option is available under a settings option and one configuration option is the use of QR code mode to provision and configure the device as described above. This allows more flexible options for configuring devices.

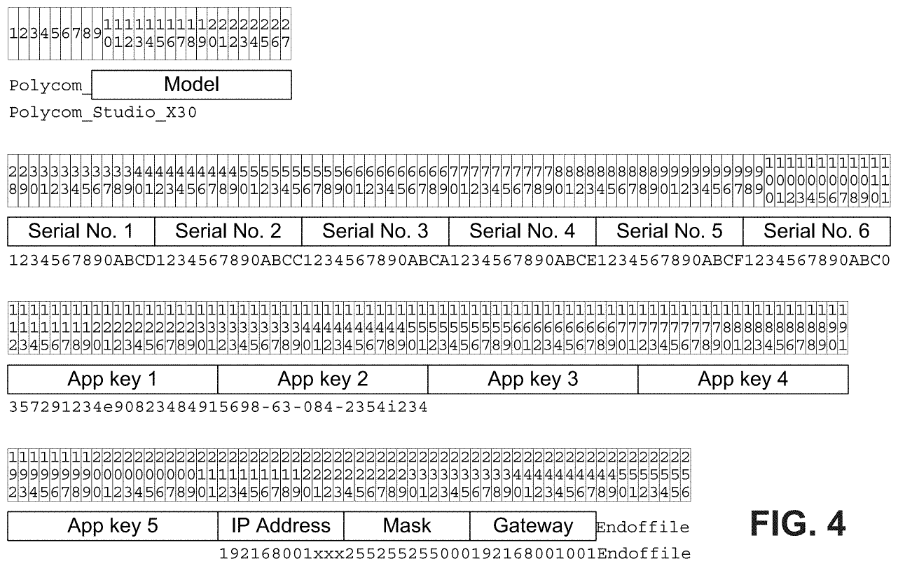

FIG. 4 illustrates the data format of an exemplary QR code for purposes of this description. It is understood that this is an exemplary QR code data format for this description and a different format and data structure would be utilized in a production environment. The format of FIG. 4 utilizes a 256 character block, which includes the manufacturer's name, the model number of the device, six positions for serial numbers, five positions for activation keys for particular applications, an IP address, a mask, a gateway address and an Endoffile indication. Greater or fewer serial number and activation key positions can be included in the data format. The IP address fields can be omitted. Other fields for other device parameters can be included.

The exemplary data block starts with the characters Polycom_and ends with the characters Endoffile in this particular example. By providing space for multiple serial numbers in the data format, a single QR code can be used to configure multiple different devices, rather than having a QR code dedicated to each device. In the IP address field, it is noted that the last three digits of the IP address are not provided. In one example the last three digits of the serial number can be utilized in as the last three digits of the IP address so that multiple different serial numbered devices can each end up with unique IP addresses.

More data can be included in the data format, such as additional configuration information, such as an alternate provisioning server IP address, programmable button values, and so on. As QR codes can contain relatively large amounts of data, numbering in the thousands of alphanumeric or numeric characters, depending on the QR code version and the desired error correction level, it is possible to encode all of the configuration data for a device into a single QR code.

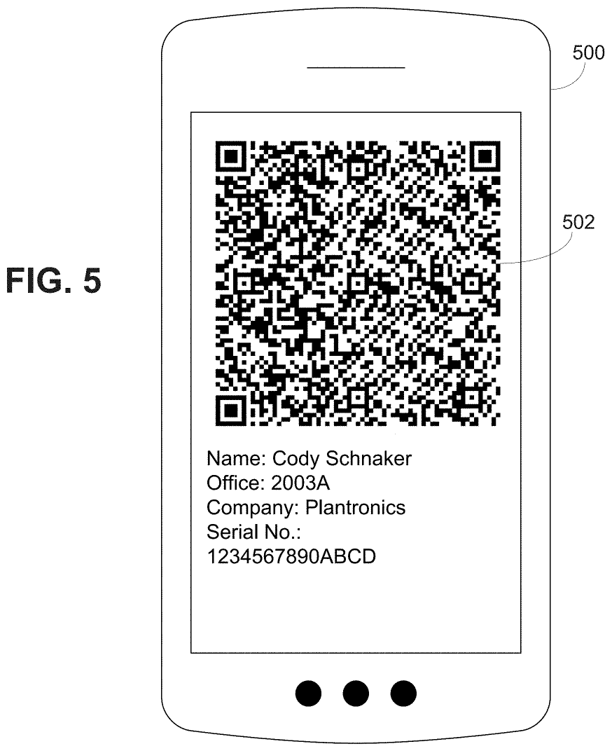

FIG. 5 is an illustration of a cell phone 500 displaying a QR code 502 to program a device having the indicated serial number and personalize it for the individual Cody Schnaker. Preferably in the using the QR code 502, both the apps are installed into or activated on the device and a fixed IP address is provided so that the device is personalized to the named individual.

To obtain the QR code 502, in one example the cell phone 500 scans a bar code including the serial number of the device being configured. The serial number is than provided to a configuration database, similar to a provisioning server but containing only the desired configuration settings, both apps and parameters, by the cell phone 500. The configuration information is returned to the cell phone 500 and the QR code 502 is developed and displayed. Alternatively, the QR code itself could be provided to the cell phone 500, limiting the dissemination of the private key used to encode the QR code data.

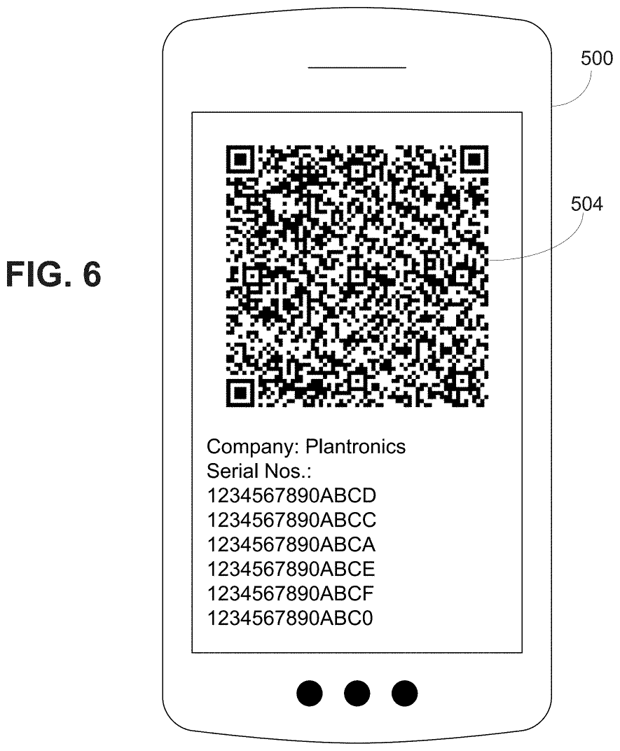

FIG. 6 indicates the cell phone 500 providing a different QR code 504 which includes the indicated six serial numbers for configuration. As the six different devices could be configured from the single QR code, in one example an IP address is not provided but that can either be provided manually later on or the device can continue to operate using DHCP. This allows the single QR code 504 to install any desired apps, such as the apps for the Zoom service or the Teams service, on multiple devices.

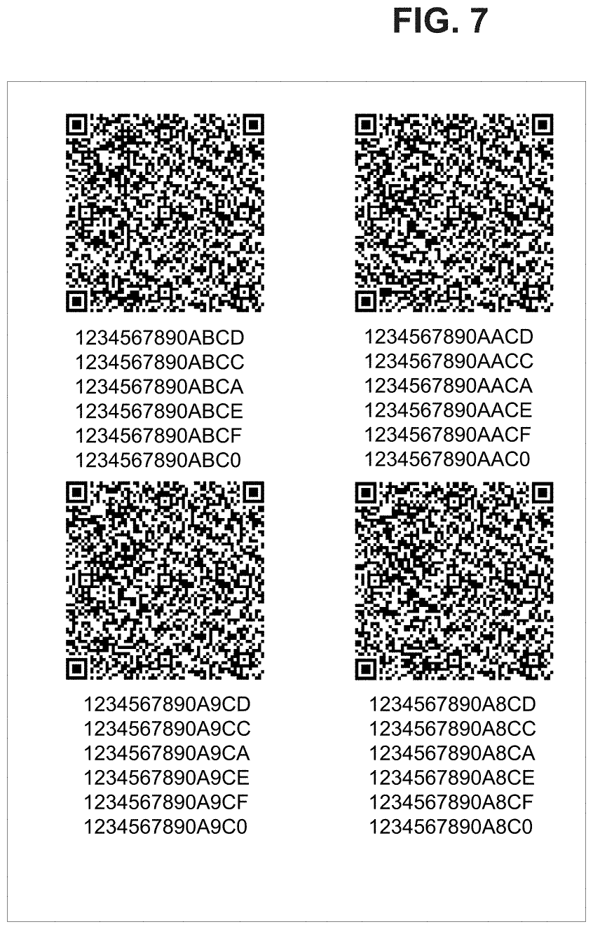

FIG. 7 is an illustration of a printed sheet of paper containing four different QR codes, each of which provides configuration information for six different devices. This allows a greater number of devices to be securely configured then with the use of the cell phone 500. Again, preferably IP addresses are not provided but app activation keys are provided so that the all devices quickly have the desired apps activated. FIG. 7 illustrates that 24 devices can be configured from a single sheet of paper in the example, so that a large installation can be performed by using a relatively limited number of sheets of paper containing QR codes. Increasing the number of serial numbers in the QR code data format allows even higher numbers of devices to be configured from a single QR code or a printed sheet of paper with multiple QR codes. Utilizing the printed sheet of paper allows the QR code or codes to be generated by the manufacturer or distributor and shipped with the device or devices.

Utilizing QR codes encoded with device serial numbers provides a simple way to securely configure devices at initial boot. The inclusion of the serial number, or even multiple serial numbers, limits the number of devices that can use a given QR code, minimizing unauthorized access to apps, while also minimizing the user efforts to configure the device. Encrypting the QR code data provides even greater security. A QR code can contain sufficient information to provide the majority, if not all, of the configuration needed for the device. The use of the QR code thus greatly reduces user actions when a provisioning server cannot be accessed, allowing quick installation of a large number of devices with reduced effort.

The various examples described are provided by way of illustration and should not be construed to limit the scope of the disclosure. Various modifications and changes can be made to the principles and examples described herein without departing from the scope of the disclosure and without departing from the claims which follow.

1. A method of configuring a device, the method comprising:
indicating a request for a machine-readable code encoding machine-readable code data;
detecting presence of a machine-readable code in front of a camera of the device;
decoding the detected machine-readable code to obtain the encoded machine-readable code data;
determining if the machine-readable code data includes data that matches the serial number of the device; and
when the machine-readable code data includes data that matches the device serial number, utilizing data in the machine-readable code data as device configuration information to configure the device.

2. The method of claim 1, wherein the machine-readable code data is encrypted, and wherein decoding the machine-readable code includes decrypting the machine-readable code data.

3. The method of claim 1, further comprising:
performing initial boot of the device;
determining if a provisioning server is accessible after completing initial boot;
when a provisioning server is not accessible, performing the indicating a request for a machine-readable code encoding machine-readable code data; and
rebooting the device after utilizing the device configuration information in the machine-readable code data to configure the device.

4. The method of claim 1, wherein the device configuration information includes at least one activation key, and wherein utilizing the device configuration information includes applying the at least one activation key to activate at least one app stored in the device.

5. The method of claim 1, wherein the machine-readable code data includes at least one serial number and device configuration information.

6. The method of claim 1, wherein the device configuration information includes an Internet Protocol (IP) address, and wherein utilizing the device configuration information includes installing the IP address as a fixed IP address for the device.

7. The method of claim 1, wherein the machine-readable code is a QR code.

8. A device to be configured at initial boot, the device comprising:
a camera;
a display;
a network interface;
a processor coupled to the camera, the display and the network interface for executing programs and operations; and
memory coupled to the processor for storing programs executed by the processor, the memory storing programs executed by the processor to perform the operations of:
indicating a request for a machine-readable code encoding machine-readable code data on the display;
detecting presence of a machine-readable code in front of the camera;
decoding the detected machine-readable code to obtain the encoded machine-readable code data;
determining if the machine-readable code data includes data that matches the serial number of the device; and
when the machine-readable code data includes data that matches the device serial number, utilizing data in the machine-readable code data as device configuration information to configure the device.

9. The device of claim 8, wherein the machine-readable code data is encrypted, and wherein decoding the machine-readable code includes decrypting the machine-readable code data.

10. The device of claim 8, wherein the memory further stores programs executed by the processor to perform the operations of:
performing initial boot of the device;
determining if a provisioning server is accessible after completing initial boot;
when a provisioning server is not accessible, performing the indicating a request for a machine-readable code encoding machine-readable code data; and
rebooting the device after utilizing the device configuration information in the machine-readable code data to configure the device.

11. The device of claim 8, wherein the memory further stores apps executed by the processor, wherein the device configuration information includes at least one activation key, and wherein utilizing the device configuration information includes applying the at least one activation key to activate at least one app stored in the memory.

12. The device of claim 8, wherein the machine-readable code data includes at least one serial number and device configuration information.

13. The device of claim 8, wherein the device configuration information includes an Internet Protocol (IP) address, and wherein utilizing the device configuration information includes installing the IP address as a fixed IP address for the device.

14. The device of claim 13, wherein the machine-readable code is a QR code.

15. A non-transitory processor readable memory containing programs that when executed cause a processor to perform the following method of configuring a device at initial boot, the method comprising:
indicating a request for a machine-readable code encoding machine-readable code data on the display;
detecting presence of a machine-readable code in front of a camera of the device;
decoding the detected machine-readable code to obtain the encoded machine-readable code data;
determining if the machine-readable code data includes data that matches the serial number of the device; and
when the machine-readable code data includes data that matches the device serial number, utilizing data in the machine-readable code data as device configuration information to configure the device.

16. The non-transitory processor readable memory of claim 15, wherein the machine-readable code data is encrypted, and wherein decoding the machine-readable code includes decrypting the machine-readable code data.

17. The non-transitory processor readable memory of claim 15, wherein the method further comprises:
performing initial boot of the device;
determining if a provisioning server is accessible after completing initial boot;
when a provisioning server is not accessible, performing the indicating a request for a machine-readable code encoding machine-readable code data; and
rebooting the device after utilizing the device configuration information in the machine-readable code data to configure the device.

18. The non-transitory processor readable memory of claim 15, wherein the non-transitory processor readable memory further stores apps executed by the processor, wherein the device configuration information includes at least one activation key, and wherein utilizing the device configuration information includes applying the at least one activation key to activate at least one app stored in the memory.

19. The non-transitory processor readable memory of claim 15, wherein the device configuration information includes an Internet Protocol (IP) address, and wherein utilizing the device configuration information includes installing the IP address as a fixed IP address for the device.

20. The non-transitory processor readable memory of claim 19, wherein the machine-readable code is a QR code.
